(19) United States
(12) Patent Application Publication
(10) Pub. No.: US 2007/0299831 A1
(43) Pub. Date: Dec. 27, 2007

(54) Method of searching, and retrieving information implementing metric conceptual identities

(76) Inventor: Frank John Williams, Los Alamitos, CA (US)

Correspondence Address: Frank John Williams, 2711 Saint Albans Dr., Los Alamitos, CA, 90720, US

(21) Appl. No.: 11/811,715

(22) Filed: Jun. 11, 2007

Related U.S. Application Data
(60) Provisional application No. 60/812,483, filed on Jun. 10, 2006.
(60) Provisional application No. 60/841,780, filed on Aug. 31, 2006.
(60) Provisional application No. 60/851,227, filed on Oct. 12, 2006.
(60) Provisional application No. 60/854,664, filed on Oct. 25, 2006.
(60) Provisional application No. 60/861,168, filed on Nov. 27, 2006.

(51) Int. Cl. G06F 17/30

(52) U.S. Cl. 707/3

(57) ABSTRACT

A method and system for searching and retrieving and providing information, wherein a value identifying at least one of a concept, word, phrase and sentence; and a second value for performing a mathematical operation or calculation for identifying at least one of a: third value, and value range for performing a search and retrieving operation including at least one of a said: first value, third value, and value range.

### RELATED APPLICATIONS

This application claims the benefit of: U.S. provisional patent application Ser. No. 60/812,483 filed 2006 Jun. 10, U.S. provisional patent application 60/841,780 filed 2006 Aug. 31, U.S. provisional patent application Ser. No. 60/851,227 filed 2006 Oct. 12, U.S. provisional patent application Ser. No. 60/854,664 filed 2006 Nov. 6, and U.S. provisional patent application 60/861,168 filed 2006 Nov. 27 by the present inventor.

### BACKGROUND

1. Field of the Invention

The present invention relates generally to the search and retrieval of information. More specifically to a novel method for searching and retrieving information implementing values identifying at east one of a: concept, word, phrase, and sentence; and a conceptual meter for calculating other value and/or value ranges for searching and retrieving additional information.

2. Description of Related Art

The revolution of the Internet has ignited a series of new industries, businesses, and services. Among one of its most prominent types of innovative businesses, is the search engine. Every day, more and more people from different cultures and languages use search engines to find what is important to them. However, current search engine technology experiences an average 95% of irrelevant results, and even higher percentages may be experienced when the search involves other languages. For example, in English the word “monkey” has no gender, yet in Spanish, there are two different words which differentiate a male monkey from a female monkey. Other word elements pose an even greater disadvantage to current technologies such as that experienced by verbs and their genders. For example, while in English and Spanish, verbs have no gender, in other languages such as Hebrew and Hindu verbs possess genders making it almost impossible to retrieve the proper information. More specifically, within a single language, Synonym-capable search engines can not differentiate between the words “monkey” and “monkeys,” dangerously treating many concepts as equals when indeed they are not. A further example is experienced when the search involves “similarities,” such as the words “pretty” and “gorgeous.” Although both words share an identical purpose of identifying “beauty,” their intensities are indeed completely different, which a Synonym search engine is again incapable to differentiate. A further disadvantage occurs when word enhancers, such as the words “very” and “extremely,” which are used to modify the conceptual intensity of a word, are included in the search. For example, assume that the phrase “very pretty” is an identical conceptual match to the word “gorgeous.” A query such as “very pretty,” implementing current Text-based technology, will only retrieve those records wherein the exact words “very” and “pretty” exist; while a Synonym-capable search engine will retrieve records including synonyms such as “super pretty” and “extremely beautiful;” but both engines will fail to retrieve the just mentioned assumed match or word “gorgeous.” The reason for such failure can be blamed in the word “very” (or its synonyms) since its existence in the query makes it a “required” word element for the retrieval operation. Furthermore, both search engines were unsuccessful in providing control to the user to define the range or magnitude of the search for the particular instant or query.

In view of the present limitations and shortcomings, there is a real necessity for information to be retrieved in a conceptual, controlled, organized, and globalize manner. The present invention permits the search and retrieval of information implementing the specific or global concept of a word, while unifying human knowledge regardless of its language of origin. The disclosed invention distinguishes over the prior art by providing heretofore a broader and more compelling method to identify, store, search, and retrieve information, while providing additional unknown, unsolved and unrecognized advantages as described in the following summary:

### SUMMARY OF THE INVENTION

The present invention teaches certain benefits in use and construction which give rise to the objectives and advantages described below. The method and system embodied by the present invention overcomes many limitations and shortcomings encountered when searching and retrieving information. The disclosed inventive method teaches a method for searching, and retrieving information implementing the calculation of values identifying at least one of a: concept, word, phrase, sentence, idiom, and corpus of information. In such fashion, the method can mathematically manipulate and operate querying information to increase, change or decreasing the spectrum of a query or search, while optionally giving the user directive control to manipulate the spectrum by implementing a “Control Spectrum Modifier” (CoSMo) thus selecting which information is to be ultimately found or retrieved.

### OBJECTS AND ADVANTAGES

A primary objective inherent in the above described method of use is to provide a method for storing, searching, and/or retrieving information not taught by the prior arts and further advantages and objectives not taught by the prior art. Accordingly, several objects and advantages of the invention are:

Another objective is to provide means to store information in a manner and/or means that is accessible from any language;

Another objective is to provide means for a search engine to control its conceptual searching spectrum or magnitude;

Another objective is to provide means to a user to select the conceptual intensity of records and similarities that can be retrieved;

Another objective is to allow the searching of information without the restrictions of any particular language;

Another objective is to find the intended information regardless of the client linguistic skills and education;

A further objective is to allow the retrieval of information regardless of nomenclatures;

A further objective is to decrease the time required for a client to find similar information;

A further objective is to permit focused queries by implementing substantial quantities of information without hindering the retrieval of information;

A further objective is to remove irrelevant results by permitting more detailed queries;

A further objective is to enable the cognitive manipulation of compound words and/or their meanings;

A further objective is to permit searches of archaic information implementing connotative language;

A further objective is to retrieve information based on the conceptual importance the word elements assume in a particular corpus of information;

Other features and advantages of the described methods of use will become apparent from the following more detailed description, taken in conjunction with the accompanying drawings, which illustrate, by way of example, the principles of the presently described method and its use.

### BRIEF DESCRIPTION OF THE DRAWINGS

The accompanying drawings illustrate examples of at least one of the best mode embodiments of the present method of use. In such drawings:

FIG. 1 is a non-limiting illustration of a basic numeric and/or calculative value identifying at least one of a: concept, word, phrase, sentence, idiom, and corpus of information; wherein said numeric and/or calculative value is here introduced as an “eeggi,” which is an acronym for “Engineered Encyclopedic and Global Grammatical Identities.”

FIG. 2 illustrates a basic lexicon of the inventive method;

FIG. 3 is an illustration of a converting operation of English characters to eeggi.

FIGS. 4A-4F illustrate several mathematical operations implementing a “Conceptual Spectrum Modifier” (CoSMo) for mathematically operating and/or modifying a query for defining a search spectrum of a search and retrieve operation of the inventive method;

FIG. 5 illustrates a non-limiting diagram of basic steps of the inventive method implementing exemplary search values;

FIG. 6 is a non-limiting block diagram of the main inventive method comprising a language such as English.

FIG. 7 is an illustration of a variation of the inventive method implementing words incorporating its respective eeggi as single units of information.

FIG. 8 is a variation of the inventive method implementing archaic translations.

FIG. 9 is an illustration of a further variations of the method depicted in FIG. 7.

FIG. 10 illustrates another range of values (eeggi).

FIG. 11 is an illustration of a prospective display of results of the inventive method arranging results by the numeric proximity to the original value of the query.

FIG. 12 is a non-limiting illustration of a conceptual meter manipulating information regarding similarities.

FIGS. 13A-13C are non-limiting illustration of several examples of conceptual meters manipulation the ranges of information for performing search end retrieval operations.

FIG. 14 is a non-limiting illustration of a block diagram of a method for providing a CoSMo meter.

FIG. 15 is a non-limiting illustration of an eeggi comprising several conceptual values or forms of information.

FIG. 16 is a non-limiting illustration of an exemplary table of different eeggis of few nouns identifying an animal such as a dog including an additional language such as Spanish.

FIGS. 17A-17B are non-limiting exemplary illustrations of a “Spectrum Information” or Spin for short, identifying the number of word elements being searched as a result of a CoSMo. In addition, FIG. 17B displays the results from a word that is used to identify several concepts or meanings.

FIGS. 18A-18E are non-limiting illustrations of exemplary metric interactions and incorporations between the eeggis of words in a data corpus.

FIG. 19 illustrates a diagram of a featured here introduced as “directional conceptual searching” for retrieving records without non-associated and/or inverted concepts.

FIG. 20 is an illustration of a type-1 verb eeggi incorporating another eeggi of a noun which is also incorporating other eeggi(s) as identified by each of their corresponding incorporating capabilities.

FIG. 21 is anon-limiting illustration of an exemplary eeggi for identifying a type-2 verb which incorporates two relating noun eeggis identifying personal names in proper conceptual direction.

FIG. 22 is a non-limiting illustration of a type-3 verb eeggi incorporating other eeggis in its immediate neighborhood.

FIG. 23 is a non-limiting illustration of a pronoun type eeggi associating its information to its noun type eeggi.

FIG. 24 is a non-limiting illustration of a paragraph type eeggi.

FIG. 25B-25B are non-limiting illustrations of an inventory-noun type eeggi for identifying items present or contained in an inventory or stock and a method for displaying results from “category type queries.”.

### DETAILED DESCRIPTION

The above described drawing figures illustrate the described methods and use in at least one of its preferred, best mode embodiment, which is further defined in detail in the following description. Those having ordinary skill in the art may be able to make alterations and modifications what is described herein without departing from its spirit and scope. Therefore, it must be understood that what is illustrated is set forth only for the purposes of example and that it should not be taken as a limitation in the scope of the present system and method of use.

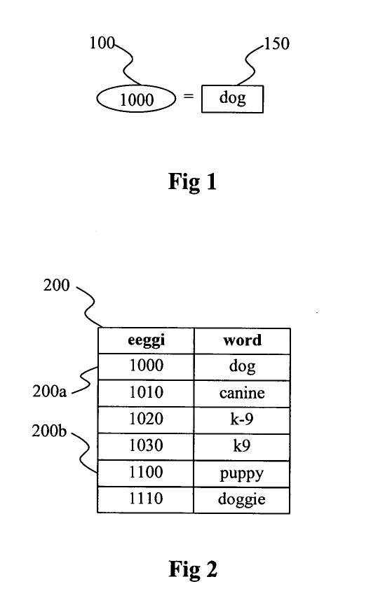

FIG. 1 illustrates a non-limiting view of a basic value or “eeggi” (Engineered Encyclopedic Globalized Grammatical Identity) identifying at least one of a: concept, word, phrase, sentence, idiom, and corpus of information. The eeggi 100 (FIG. 1) equal to a value “1000” is illustrated along its English version 150 (FIG. 1) which is the word “dog.”

FIG. 2 illustrates a lexicon 200 (FIG. 2) or table depicting an eeggi column and its English word column. As shown, the first record 200a (FIG. 2) in the table indicates that the eeggi (value) 1000 has an English translation of “dog;” while in the fifth record 200b (FIG. 2) the eeggi (value) 1100 has the English equivalent of the word “puppy.”

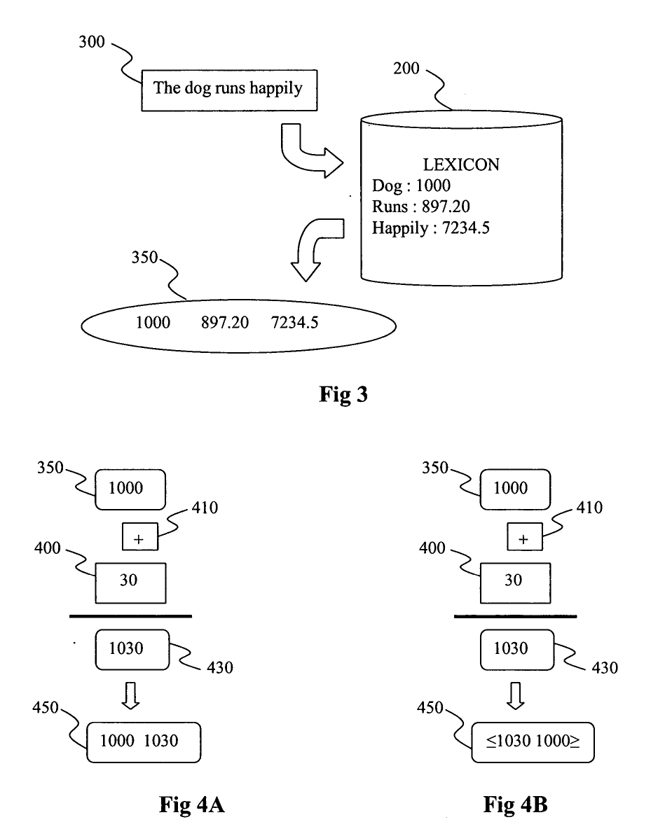

FIG. 3 illustrates an obvious method of a single translating or converting step for transforming an English corpus of information into an eeggi corpus of information. The phrase 300 (FIG. 3) or English corpus of information is converted to the eeggi corpus of information 350 (FIG. 3) implementing a lexicon 200 (FIG. 3) for translating or converting each word or group of words.

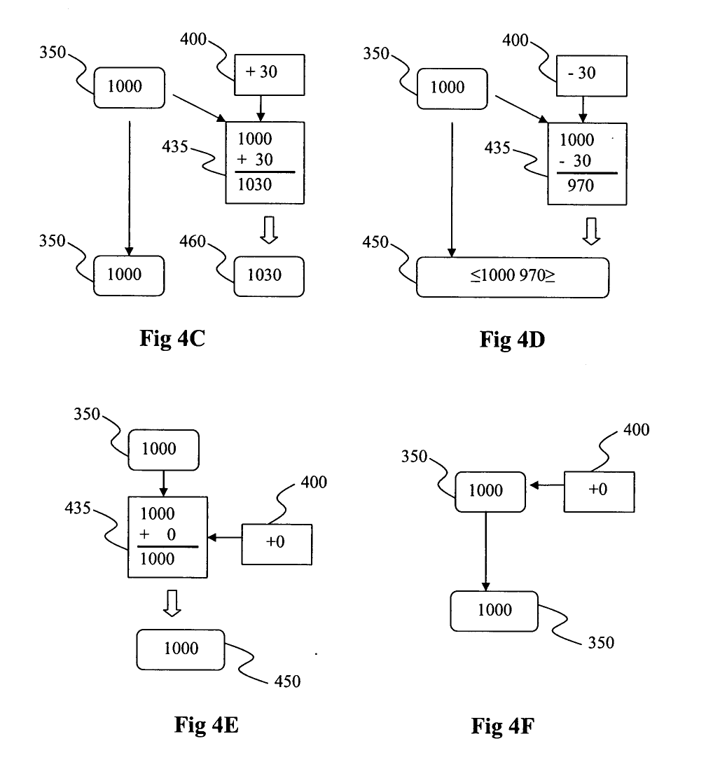

FIG. 4A illustrates a basic and exemplary mathematical operation implementing a “Conceptual Spectrum Modifier” (CoSMo) for manipulating or modifying a value(s) of a query or search operation. In this non-limiting example, the value (eeggi) from an input or query 350 (FIG. 4A) which happens to be “1000” is calculated or mathematically operated with the CoSMo 400 (FIG. 4A) which has a value of “30” implementing the mathematical operator 410 (FIG. 4A) for discovering or forming a new value 430 (FIG. 4a) for configuring a new or calculated query 450 (FIG. 4A). In this example, the calculated query 450 (FIG. 4A) comprises the values “1000” or “1030”; that is, the search will include both or at least one of the values of “1000” or “1030.” FIG. 4B illustrates a similar operation this time defining a range of values instead of an additional or substitute value. The value input 350 (FIG. 4B) is mathematically operated with the CoSMo 400 (FIG. 4B) implementing the mathematical operator 410 (FIG. 4B) for discovering or calculating a calculated value 430 (FIG. 4B) which along with the initial input value 350 (FIG. 4B) define a search range 450 (FIG. 4B). In this example the value range defines a query wherein all values equal or larger than “1000,” and/or equal or smaller than “1030” will be retrieved. In other words, the retrieval includes at least one of the values of “1000 and 1030” and/or any other value in between (i.e., 1000, 1000.10, 1005, 1029, etc.). FIG. 4C illustrates a slight variation of the inventive method depicted in FIG. 4A by implementing several queries instead of a larger or volume query. In FIG. 4C, the initial query 350 (FIG. 4B) is kept identical and is searched, but its information is used to form an additional value or calculated query 460 (FIG. 4B) implementing the CoSMo 400 (FIG. 4C) through the mathematical operation 435 (FIG. 4C). Please note that in this example, the CoSMo 400 (FIG. 4C) implied the type of mathematical operation (“+” sign or addition). FIG. 4D illustrates a further example of a CoSMo with negative value, and a range for searching. The input query 350 (FIG. 4D) is operated with the CoSMo 400 (FIG. 4D) using a subtraction operation 435 (FIG. 4) for discovering or identifying a search range 450 (FIG. 4D) for performing a search. FIG. 4E depicts a search behavior with an outcome similar to that of Text-based search engines. In this example the input query 350 (FIG. 4E), is calculated 435 (FIG. 4E) implementing the CoSMo 400 (FIG. 4E) which is equivalent to zero. Therefore, the calculated value 450 (FIG. 4E) equals the original value 350 (FIG. 4E), leading to a single value search, thus resembling Text-based methodologies results. FIG. 4F illustrates an example of a further similar behavior. The input eeggi or value 350 (FIG. 4F) is not mathematically operated on, because the value of the CoSMo 400 (FIG. 4F) is equal to zero thus defining the search query 450 (FIG. 4F) the same as the original input query 350 (FIG. 4F). As illustrated, from FIGS. 4A to 4F, there is indeed a myriad of possibilities to mathematically operate an input value (eeggi) for defining a particular value, and value range. In addition, there is a large variety of search behaviors, and/or queries capable of adopting or incorporating such results from mathematical operations. For example, the CoSMo in any of the figures could have involved a percentage(s) instead of an integer, or the calculated query could have avoided its highest value while still considering any other values in between, or the query could be referred to the database, which in association with the CoSMo are used for identifying values ranges or even word groups for searching through several independent searches or numeric range searches, etc.

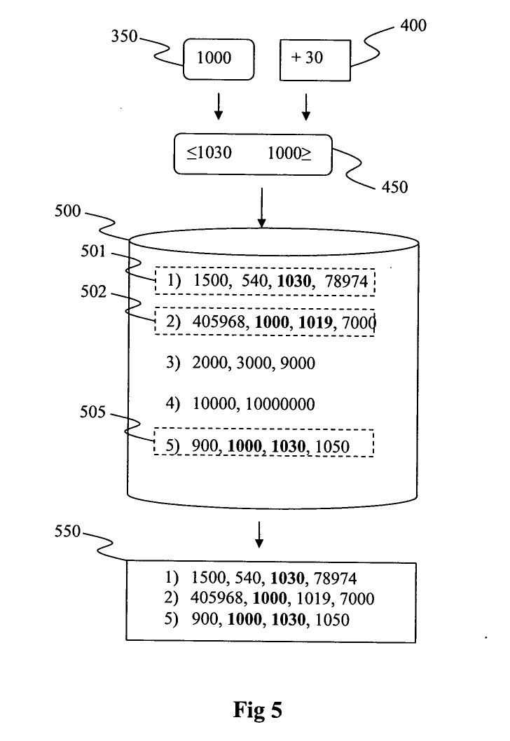

FIG. 5 illustrates a non-limiting generalized block diagram of the basic steps of the inventive method, including an exemplary search of values or eeggis. The initial query 350 (FIG. 5) comprising the value (eeggi) of “1000,” and the CoSMo 400 (FIG. 5) comprising the value of “+30” mathematically interact for defining a range of a Calculated query 450 (FIG. 5). The range implies that searched results must comprise at least one value from “1000” to “1030.” The search is executed upon the source for information 500 (FIG. 5) also known as database for records for producing the result 550 (FIG. 5). Please note, in the database for records 500 (FIG. 5), record 1 501 (FIG. 5), record 2 502 (FIG. 5), and record 5 505 (FIG. 5) contain matching values; therefore, the resulting records 550 (FIG. 5) comprise such records (1, 2, and 5). In addition, please note that at least one value from the second or Calculated query 450 (FIG. 5) was sufficient to generate a result (“and/or” type query) such as that of record number 1 501 (FIG. 5) in the source of information 500 (FIG. 5) which contains or has only one value (1030) as identified by the query's range. Record number 2 502 (FIG. 5) has two values identified by the range or spectrum, including a limit value (1000) and a mid-value (1019); while the fifth record 505 (FIG. 5) contains both delimiting values (1000 and 1030) which define the range or value spectrum.

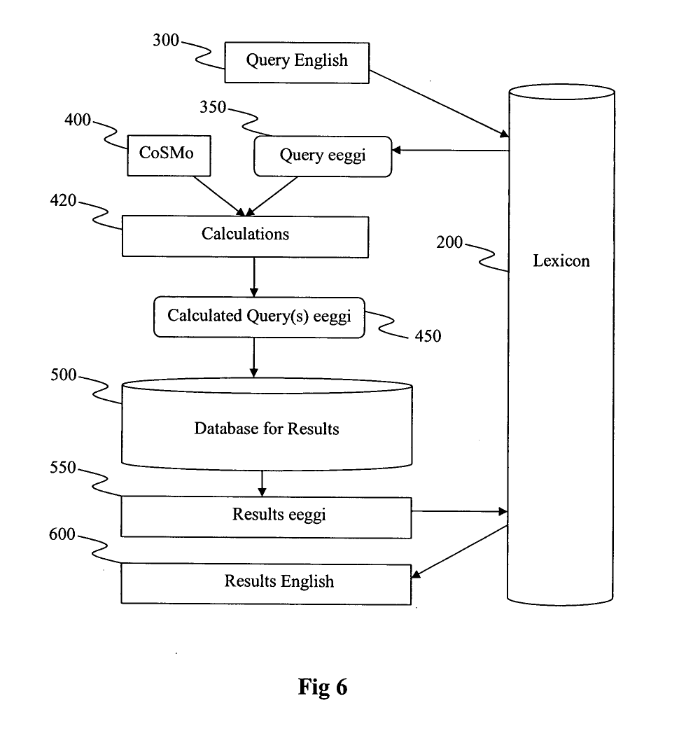

FIG. 6 illustrates a non-limiting block diagram of the inventive method comprising a language such as English. The query in a natural language 300 (FIG. 6) such as “English” is translated or converted implementing the Lexicon 200 (FIG. 6). The converted or eeggi query 350 (FIG. 6) is calculated 420 (FIG. 6) implementing a CoSMo 400 (FIG. 6), thus forming the new Calculated query 450 (FIG. 6). The search is then executed upon the database for records 500 (FIG. 6) for producing the results 550 (FIG. 6) which are translated implementing the lexicon 200 (FIG. 6) to their English version 600 (FIG. 6). Please note, that the database for records 500 (FIG. 6) contains eeggis, which could have being originated from any language other than English. In addition, please note that while eeggis can suggestively be used as entire new language, its implementation such as “anchor values” is also possible; wherein “anchor values” refers to indexing the eeggis to point to the information on the specific natural language. In such fashion, when the information is found using eeggi, the indexes identify the information in the natural language therefore removing the necessity to translate the eeggi into the natural language.

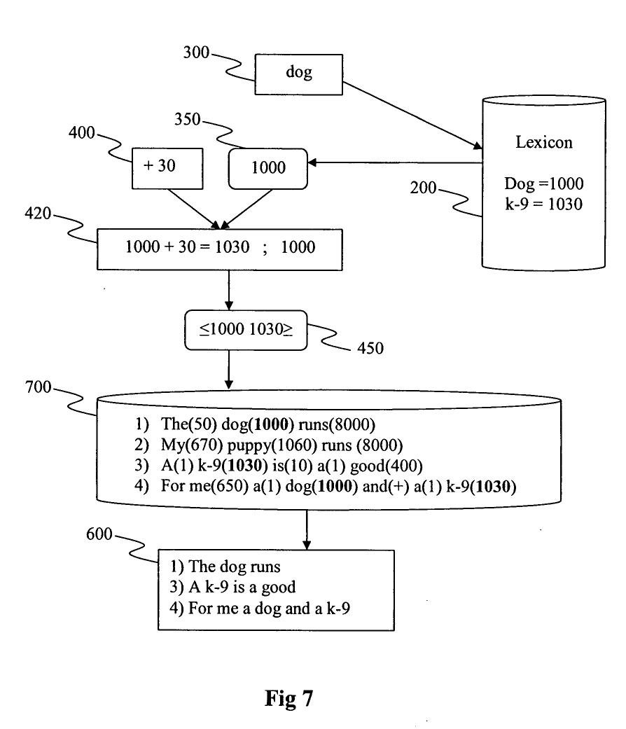

FIG. 7 illustrates a variation of the inventive method from FIG. 6, including exemplary values or eeggis performing the search. In this non-limiting example, the word and its eeggi (value) form a single unit for searching. The query entry 300 (FIG. 7) is converted using the lexicon 200 (FIG. 7) to the second query 350 comprising the eeggi; which according to the CoSMo 400 is once again reformulated or mathematically operated 420 (FIG. 7) to form the third or Calculated query 450 (FIG. 7). The search is then executed upon the source for information 700 (FIG. 7) for producing the results 600 (FIG. 7) simply by excluding or filtering their eeggi portion(s).

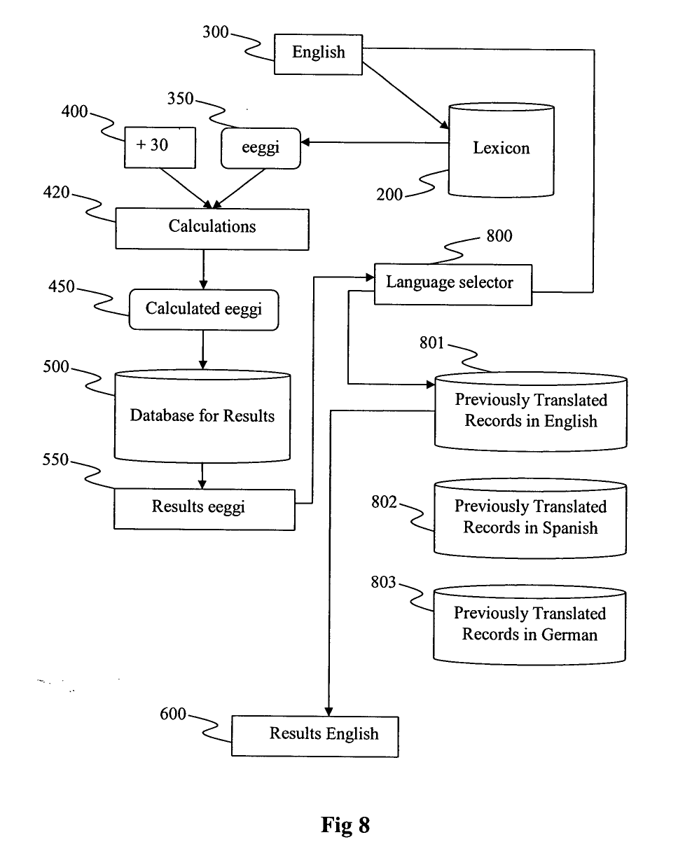

FIG. 8 illustrates another variation of the inventive method from FIG. 6. In this non-limiting example, the display of results on a given natural language is the outcome of an indexing method of archaic pre-translated results, or in other words, the resulting eeggis from the search are indexed to a database of previously translated version(s) on one or many natural languages, thus allowing the search engine to quickly display results without the immediate necessity of translating the eeggis since they were already previously translated. The entry query 300 (FIG. 8) in converted to eeggi 350 (FIG. 8) using the lexicon 200 (FIG. 8). Then the CoSMo 400 (FIG. 8) and the query 350 (FIG. 8) are calculated 420 (FIG. 8) for discovering the new Calculated query 450 (FIG. 8). Then the search is executed upon the Database for Records 500 (FIG. 8) producing the eeggi Results 550 (FIG. 8), then the language selector 800 (FIG. 8) points the eeggi results 550 (FIG. 8) to the previously translated English version 801 (FIG. 8), for finally displaying the results in said selected English language 600 (FIG. 8). Please note, the Language Selector 800 (FIG. 8) can be an automatic function of the language used in the entry query 300 (FIG. 8) and/or be a selective function that the user specifies such as at least one of a: displaying results in the natural language(s) of the entry query 300 (FIG. 8), displaying results in the natural language(s) of origin of the records, and displaying results in the natural language(s) of choice. In addition, please note, that the English records 801 (FIG. 8) or any other could be an integral part (not separated) of the database for records 500 (FIG. 8).

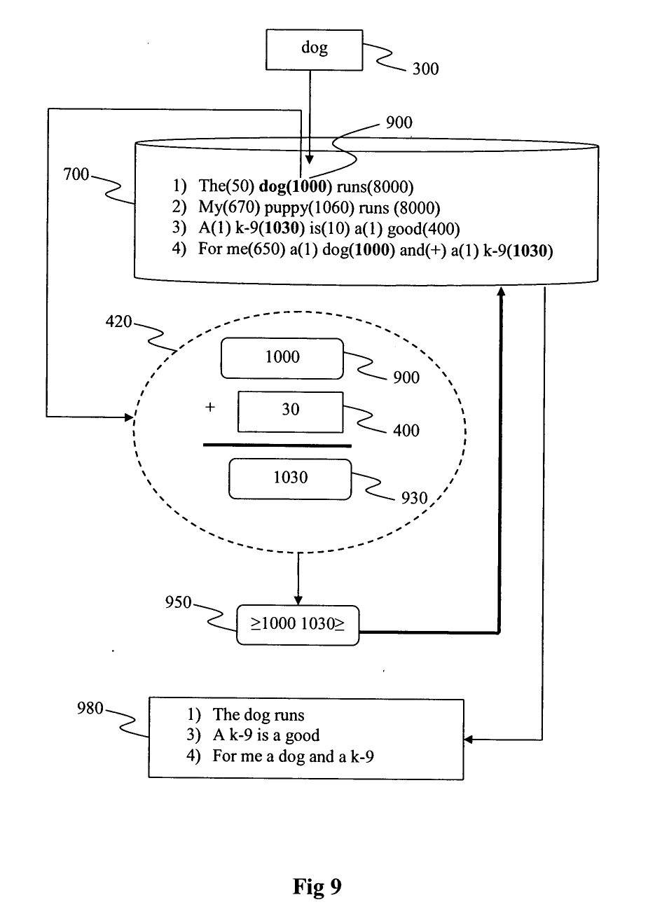

FIG. 9 illustrates a further variation of the inventive method depicted in FIG. 7. The word of the entry query 300 (FIG. 9) is searched and found in the database for information 700 (FIG. 9). The eeggi portion or value 900 (FIG. 9) is selected and mathematically operated 420 (FIG. 9) implementing the CoSMo 400 (FIG. 9) for discovering the additional or calculated value “1030” 930 (FIG. 9) for defining the new calculated query 950 (FIG. 9). Please note, that the calculated query 950 (FIG. 9) includes any value from “1000 to 1030.” A second search, this time implementing the values of the range defined by the calculated query 950 (FIG. 9) is now executed upon the database for information 700 (FIG. 9). The results 980 (FIG. 9) now include all those records with matching values as defined by the calculated query 950 (FIG. 9). Please note, that the eeggis in the results 980 (FIG. 9) have already been removed, therefore displaying results in their natural language of origin (or other).

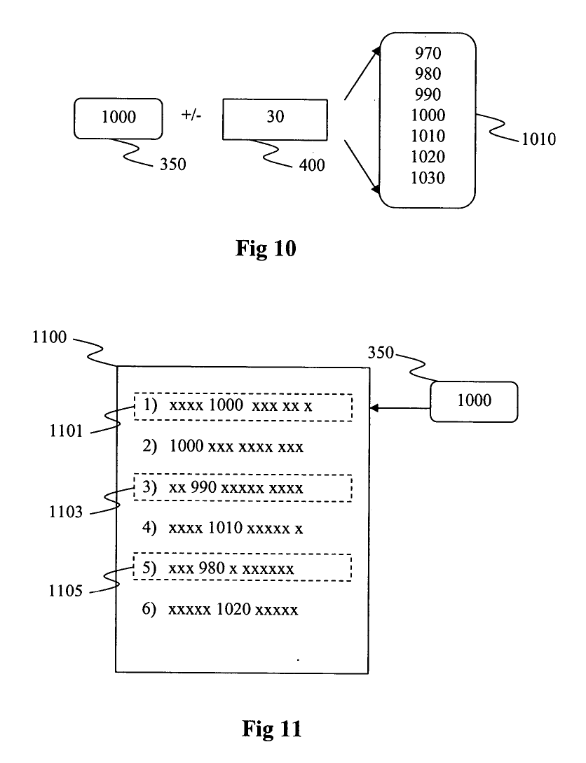

FIG. 10 illustrates a variation of a prospective type of value range. The eeggi “1000” from the query 350 (FIG. 10) is modified or calculated by the CoSMo 400 (FIG. 10) for producing the range 1010 (FIG. 10) for searching results comprising values below “1000” and above “1000;” that is, from “970” to “1030.” Please note, that a subtraction operation was included along with an adding operation.

FIG. 11 illustrates a non-limiting display of results. The results list 1100 (FIG. 11) is a prospective array or arrangement for providing or displaying the results based on the numeric proximity to the initial numeric query or eeggi 350 (FIG. 11). For example, the first displaying record 1101 (FIG. 11) matches the query value and therefore is displayed first. The third record 1103 (FIG. 11) with a value of “990” is displayed after all matching values; while the fifth record 1105 (FIG. 11) is displayed further below since its value of “980” presents an even greater difference.

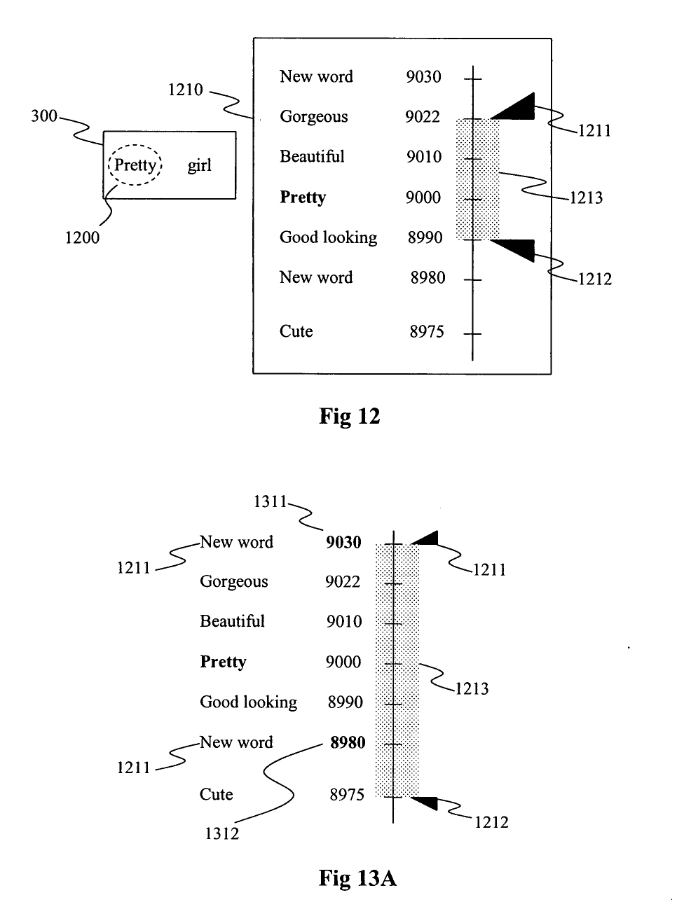

FIG. 12 illustrates an evolved version of a Conceptual Spectrum Modifier (CoSMo) depicting a form of a “meter” for modifying or controlling a single value or range of values of a concept such as that of an adjective, which can easily involve similarities rather than synonyms. In this particular example, the natural language information or query 300 (FIG. 12) comprises two words, the adjective “pretty” and the noun “girl.” After right clicking (or other activating type action) the word “pretty,” 1200 (FIG. 12), the CoSMo Meter 1210 (FIG. 12) is displayed identifying the several similarities associated to the word “pretty,” allowing the user the option to select a desired word and/or range of words for searching information. Also illustrated in FIG. 12 are the maximum delimiter 1211 (FIG. 12) for defining the upper or maximum value, and the minimum delimiter 1212 (FIG. 12) for defining the lower or minimum value; for identifying the value range 1213 (FIG. 12) which in this case of this illustrated example totals a value of “32” (9022−8990=32).

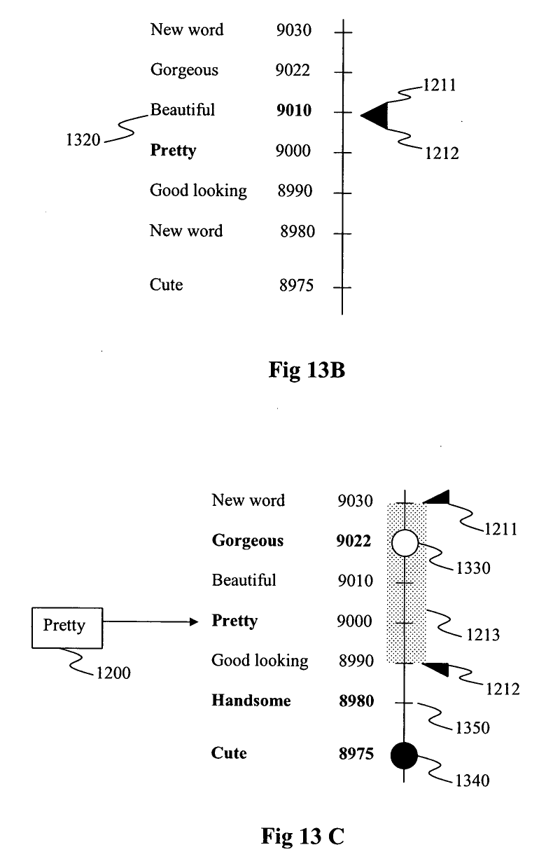

FIG. 13A, FIG. 13B, and FIG. 13C illustrate several controlling or modifying samples of inputs implementing the “CoSMo meter” depicted in FIG. 12 used for controlling or defining a particular search spectrum. In FIG. 13A, in comparison to FIG. 12, the upper value or maximum delimiter 1211 (FIG. 13A) has being moved up to face and/or include the value “9030,” and the lower value or minimum delimiter 1212 (FIG. 12A) was moved down to include the word “cute” or respective underlying eeggi (value) “8975.” Please note that the values “9030” 1311 (FIG. 13A) and “8980” 1312 (FIG. 13A) are undefined or identified as “New word,” implying that no English word exists to be associated to such value(s). As a consequence, any searches including values that do not have an associated word, can prospectively be discarded or its results be substituted with words which values are the closest to the unidentified values. For example, the range 1213 (FIG. 13A) includes the value “9030.” Any results comprising the value “9030” may be removed or they maybe displayed using the word “gorgeous” since its value “9022” is the closest to that of “9030.” Noteworthy, the values “9030” 1311 (FIG. 13A), “8980” 1312 (FIG. 13A) can easily incorporate new or future English words (adjectives) for defining additional intensities of the concept “pretty” and its similarities. FIG. 13B illustrates a sample in which the maximum delimiter 1211 (FIG. 13B) and the lower delimiter 1212 (FIG. 13B) were placed together or closed; thus defining the single value of “9010” which corresponds to the word “beautiful” 1320 (FIG. 13B). As a result, only those records comprising the value of “9010” will be retrieved (the search engine produces results similar to a text-based engine). Furthermore, positioning of the delimiters over other value regions allows the search engine to retrieve other value(s) optionally excluding even the original input value or original word “pretty” itself, thus “shifting” the search to a different word, value and/or value range as well. FIG. 13C illustrates a further example. The meter corresponding to the word “pretty” or query 1200 (FIG. 13C) illustrates a maximum delimiter 1211 (FIG. 13C) and minimum delimiter 1212 (FIG. 13C) defining a region 1213 (FIG. 13C), wherein the “white” filled circle 1330 (FIG. 13C) indicates that its corresponding word of “gorgeous” or value “9022” is to be avoided in the search or removed from the results. Also, the “black” filled circle 1340 (FIG. 13C) indicates that the value “8975” or word “cute” is to be included or added without comprising other neighboring values (or words) such as the value “8980” 1350 (FIG. 13C) which is identifying the word “handsome.”

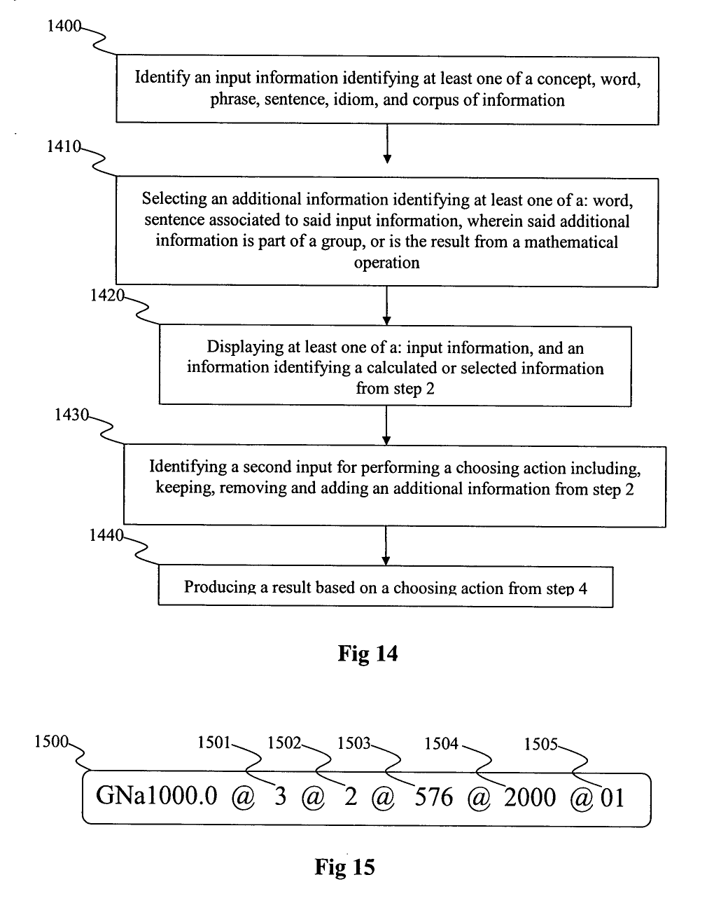

FIG. 14 illustrates a non-limiting block diagram for generating a CoSMo meter for keeping, adding or removing a word and/or others elements from search results, with or without implementing a mathematical operation. The first step 1400 (FIG. 14) of the method involves identifying an input information 1400 (FIG. 14) such as a word, phrase, sentence, etc. which in the second step 1410 (FIG. 14) is used for producing and/or selecting at least another word implementing at least one of a: mathematical operation or group identifying action. On the third step 1420 (FIG. 14), the additional word element is displayed allowing the user to keep, add, or remove such additional information from the search operation(s). On the fourth step 1430 (FIG. 14), the user chooses or keeps which word(s) are to be implemented on the search. On the final or fifth step 1440 (FIG. 14) the results from the search are displayed based of the choices the user agreed or entered on the previous fourth step. Please note, in a search engine not implementing values, the CoSMo meter can still be used to restrict or manipulated the number of words that will be searched from a particular word group. For example, the search engine has a CoSMo meter set at “2” suggesting that searches will include up to two more additional words. Therefore, if a query such as “pretty” is inputted, the results will contain only two more additional words such as “gorgeous” and “beautiful” although the word group of the word “pretty” has approximately six words. Increasing the CoSMo meter to “5” will include other words in the results such as “cute,” “good looking,” and “handsome” per se.

FIG. 15 illustrates a superior eeggi capable of incorporating additional conceptual values for identifying and providing user access to search for additional and/or more detailed information. The exemplary eeggi 1500 (FIG. 15) comprises several optional and additional information regarding the concept which the eeggi is identifying, that in this case happens to be a type of a noun. The additional information is this example includes: the “gender value” 1501 (FIG. 15) used for identifying the gender or sexual persona of the noun, the “singularity value” 1502 (FIG. 15) used for identifying the number of elements the noun represents, the “species value” 1503 (FIG. 15) used for identifying its natural state such as a living organism, the “active metric value” 1504 (FIG. 15) used for identifying particular values specially for performing primary or secondary mathematical operations between several interacting eeggis, and finally the “language value” 1505 (FIG. 15) used for identifying the original language or even the actual word in the respective original language. Please note, with the exceptions of the “active metric value” 1504 (FIG. 15) and the “language value and/or word identification” 1505 (FIG. 15), the other exemplary conceptual values of “gender value” 1501 (FIG. 15), “singularity value” 1502 (FIG. 15) and “species value” 1503 (FIG. 15) manipulate and/or modify the concept identified by the noun eeggi, which actually is an event common to many languages. For example, in English the plural of the noun “man” is identified by “men;” which is a different word, but the eeggi can use a different value for identifying the plurality of elements without departing from the actual spirit or concept it represents. To facilitate this illustration, the eeggi in FIG. 15, uses the symbol “@” to separate the additional conceptual values. In addition, the “GNa” portion of the eeggi 1500 (FIG. 15) is used to identify a larger value or range of values, which in this example is reserved for identifying groups of particular type element such as adjectives, verbs, etc. In addition, the user can potentially access the additional spectrums to modify the query as desired simply by right clicking the word in the query.

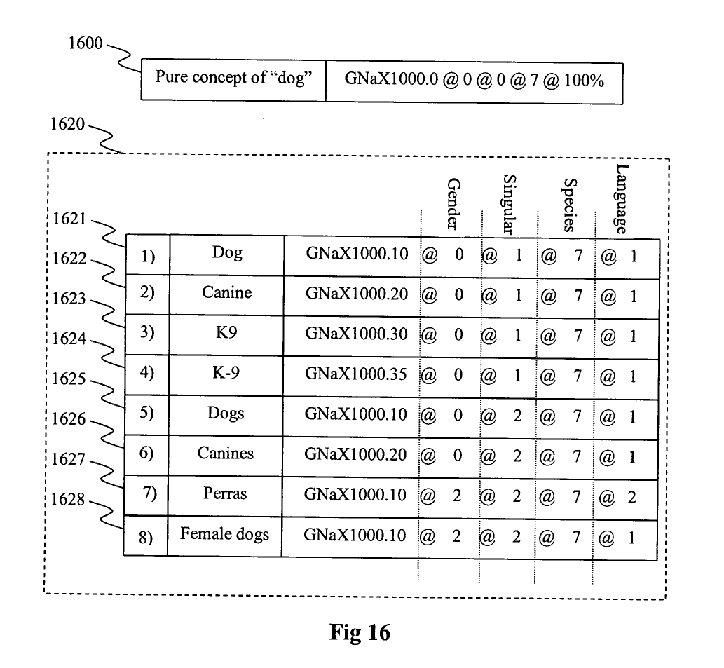

FIG. 16 illustrates an exemplary table of eeggis of few nouns modified by their particular language versions. The pure and unaltered concept of “dog” 1600 (FIG. 16) and its non-limiting master eeggi are depicted above the English and Spanish table 1620 (FIG. 16) illustrating different versions of the concept “dog.” Please note that the pure or master eeggi 1600 (FIG. 16), has the exemplary values of “0” in most of its additional conceptual values, wherein “0” in this example is used to identify a “non-identified” or “non-limiting” value. However, in table 1620 (FIG. 16), the first record 1621 (FIG. 16) “dog” has an eeggi with value “GNaX1000.10” including a decimal value of [0.10] while in the second record 1622 (FIG. 16) the eeggi of “canine” has a decimal value of [0.20]. Notable, both records still share the same additional conceptual values on the other spectrums; such as “0” in gender (no specific sex), “0” for singular value (one entity), “7” for species (organic animal living entity), and “1” for language. In similar fashion, the third record 1623 (FIG. 16) “K9” and the fourth record 1624 (FIG. 16) “K-9” share equal spectrums, except for their decimal value, enabling the search engine of identifying each of them specifically. The fifth record 1625 (FIG. 16) shows the word “dogs” having a number “2” in the singular column, identifying its plurality, while in the first record, 1621 (FIG. 16) “dog” has a number “1” in the singular column for identifying its singularity. In similar fashion, the second record 1622 (FIG. 16) “Canine,” and the sixth record 1626 (FIG. 16) “Canines” differ values in the singular spectrum. The seventh record 1627 (FIG. 16) “perras” which is Spanish for female dogs, has a gender spectrum of “2” for female, and a singular spectrum of “2” for plurality. The eighth record 1628 (FIG. 16) the phrase “female dogs,” is practically an equivalent to “perras” except for their language spectrum. Noteworthy, in order to search for all the synonyms of dog, the search engine needs to retrieve all those records with value “GNaX1000” ignoring decimals and other spectrum values; while to search for “dog's plurals,” implies that the search engine must also retrieve those records having a number “2” in the singular spectrum. Other grammatical elements such as verbs can further benefit from such detailed distinctions. For example, in the language of Hindu, the verb “go” has a gender, enabling for the following two scenarios: first, allowing an English speaking person to be verb-gender-specific; and second, allowing an Hindu speaking person to find all information even when his/her input was gender specific (when the eeggi's gender value is undefined or “0” the eeggi may still be retrieved) while respecting gender specific records such as those originated from Hindu language and/or other languages making gender of verbs.

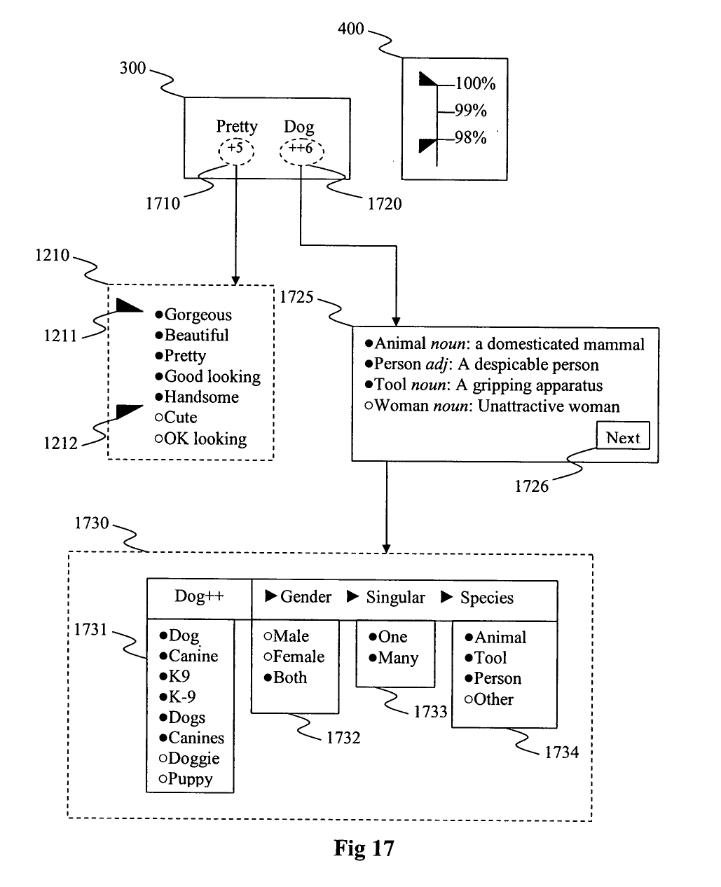

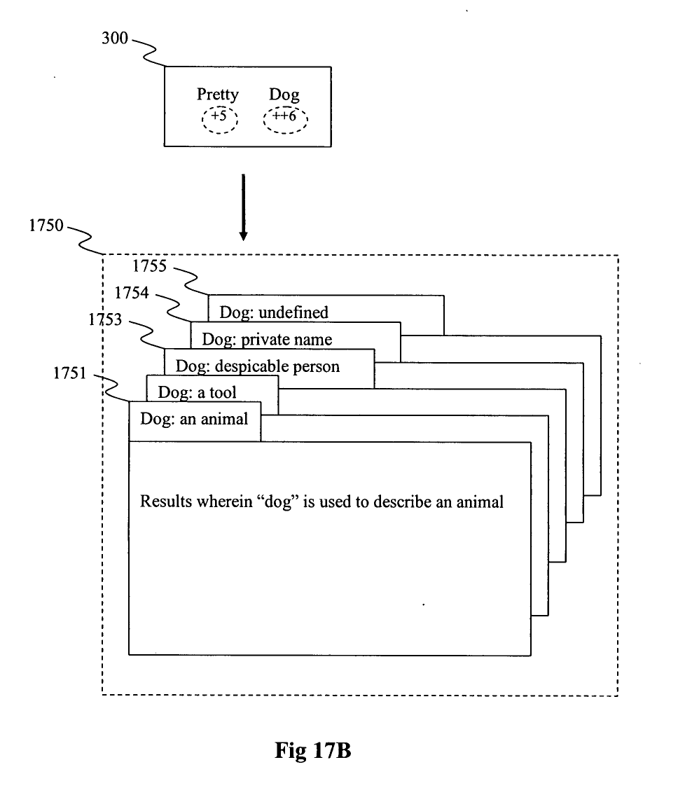

FIG. 17A is an exemplary illustration of a user manipulating the “Spectrum Information” (SpIn) or information identifying the range of additional words or possible total number of words to be searched, resulting from a CoSMo meter setting or value, and the underlying calculated value(s) of additional eeggis. In FIG. 17A, the entry query 300 (FIG. 17A) displays the first SpIn “+5” 1710 (FIG. 17A) under the word “pretty” identifying the number of additional words relating to “pretty;” and the second SpIn “++6” 1720 (FIG. 17A) under the word “dog,” identifying the number of additional words, and additional number of concepts relating to entry word “dog.” Please note, the CoSMo meter 400 (FIG. 17A), in this particular example, regulates both entry words and is ultimately responsible for the number the SpIn assumes or displays. Furthermore, clicking each Spin enables access to the CoSMo of each word. For example, clicking the first SpIn 1710 (FIG. 17A) exhibiting a value of “+5” produces a display of its CoSMo 1210 (FIG. 17A), for controlling to the number of adjectives, which is modifiable by moving the maximum delimiter 1211 (FIG. 17A) and the minimum delimiter 1212 (FIG. 17A); while clicking the second SpIn 1720 (FIG. 17A) permits access to other information before its respective CoSMo becomes available. This is because the exemplary Spin has two “++” signs, indicating that the lexicon contains several eeggis (meanings) associated to the word “dog.” In this example, clicking the second SpIn “++6” 1720 (FIG. 17A) resulted on the meanings menu 1725 (FIG. 17A) identifying all concepts available under “dog” enabling the user to further select the desired meaning(s). Clicking each of the filled-black circles changes it to an unfilled-white circle, removing the eeggi or concept from the searched results. After selecting a meaning, the “Next” key 1726 (FIG. 17A) provides access the corresponding CoSMo 1730 (FIG. 17A). In this example, the CoSMo 1730 (FIG. 17A) controlling the meaning of a “domestic mammal” is displayed. The CoSMo 1730 (FIG. 17A) provides a series of modifiers or sub-controls to manipulate relative and specific information of the eeggi. For example, the noun sub-menu 1731 (FIG. 17A) provides selective control to the nouns that are to be included in the search. The Gender sub-menu 1732 (FIG. 17A) allows the user to select a gender of the noun. The Singular menu 1733 (FIG. 17A) allows the user to specify the plurality of the entity. As result, the search engine can selectively retrieve superior results. However, in the event that no selection of a meaning occurs, the search engine can still separate and categorize the results by eeggi or meaning, thus providing groups of results wherein each group contains a single meaning of the multi-conceptual word such as that of “dog” used in this example. Noteworthy, modifying the CoSMo meter 400 (FIG. 17A) to an exemplary value of “99%” will change the value of each Spin to “+2” and “++4” per se; while specific selections within the particular eeggis themselves, such as gender and others, will change the value of the CoSMo meter 400 (FIG. 17A) to “custom percentage” per se. Also, enabling the display of the SpIn could be an additional feature of the search engine. In addendum, further controls can prospectively modify the range or spectrums that a particular meter number has access to modify or identify. FIG. 17B is a non-limiting illustration of the results generated when a query containing a multi-conceptual word is searched without specifying a meaning. The query 300 (FIG. 17B) produces the results 1750 (FIG. 17B); wherein tabs identify the meaning that each group of records contains. For example, the first tab 1751 (FIG. 17B) named “Dog: an animal” identifies the page or group of results wherein the word “dog” is used to identify an animal. Clicking the third tab 1753 (FIG. 17B) displays those records wherein the “dog” is now used to describe a despicable person. The fourth tab 1754 (FIG. 17B) will display those records wherein “dog” is used as a private name, such as that, for example, naming a rock group, a song, or a pet supply store. The fifth tab 1751 (FIG. 17B) identifies the results wherein the word “dog” is identifying an unknown concept or eeggi(s) for identified such situations. Please note, a possible function of “asking the user to select the meaning” of the multi-conceptual word(s) before the search results are displayed may be enforced at all times or activated only when the number of meanings from multi-conceptual words exceeds a predetermined number.

From an analytical point of view, nouns, adjectives, verbs, adverbs, and other grammatical elements conceptually, or for the purpose of the present disclose inventive method “metrically” add, remove, enhance or interact their information between each other. The following figures (18A-18E) explore or depicted some of the metric interrelationships possibly attained or acknowledged through the present disclosure.

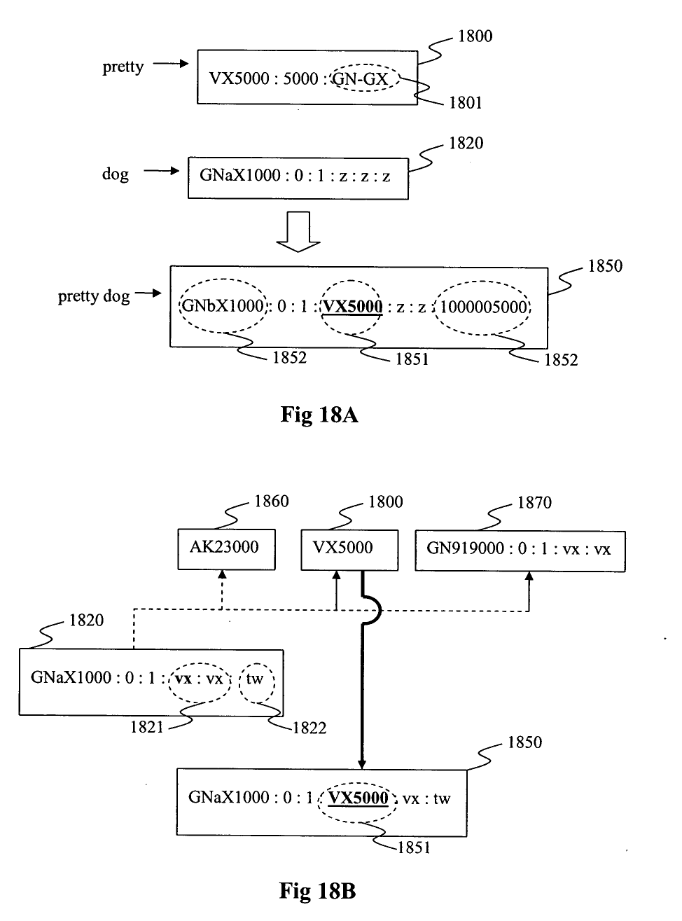

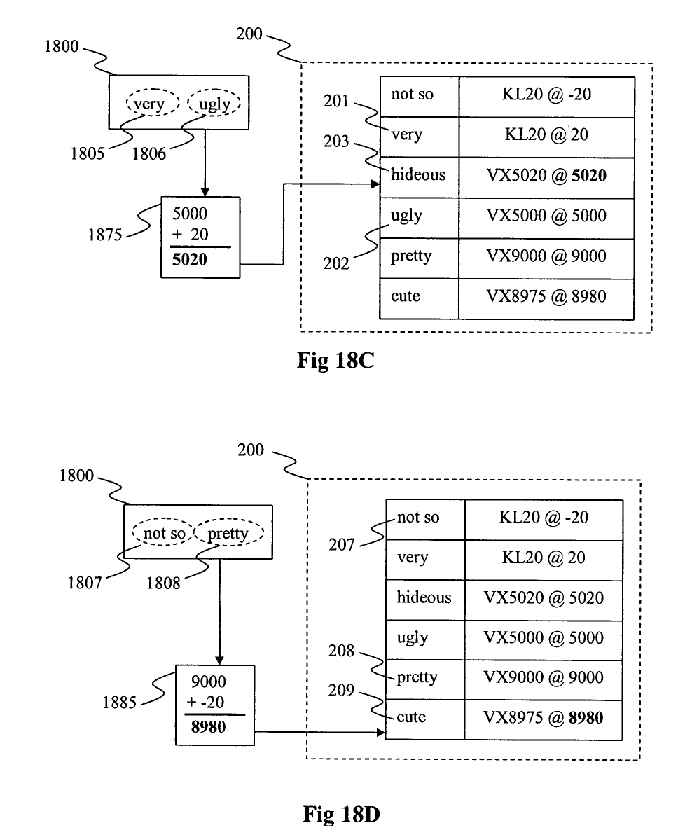

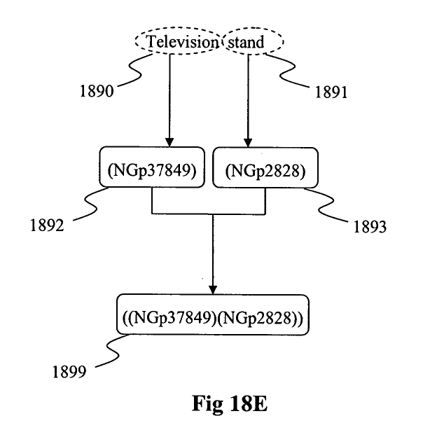

FIG. 18A depicts an exemplary relationship between adjectives and nouns. In similar fashion to what happens in natural language, the adjective provides information to the noun, or better yet, for the purpose of the inventive method, the adjective, metrically speaking, “adds” its information to the noun. The adjective eeggi 1800 (FIG. 18A) provides its information to the noun eeggi 1820 (FIG. 18A), resulting on the new compound noun eeggi 1850 (FIG. 18A) which now has incorporated information from the exemplary adjective. In fact, the compound noun eeggi 1850 (FIG. 18A) includes the information 1851 (FIG. 18A) which is the value of the adjective eeggi. In addition, the compound noun eeggi 1850 (FIG. 18A) also includes the total formulated value 1852 (FIG. 18A) resulting from a mathematical operation of the noun eeggi's value and adjective eeggi's value; and finally the compound noun eeggi 1850 (FIG. 18A) includes the modified eeggi identification 1852 (FIG. 18A), which was transformed from “GNa” to “GNb.” FIG. 18A also serves to illustrates how values can be implemented as categories, wherein the value of a noun is to be much larger than those values identifying adjectives. In addition, FIG. 18A also illustrates an optional yet important feature that can be bestowed by each type eeggi, wherein only an adjective type eeggi can be “incorporated” into a noun type eeggi and not the other way around (similar to what occurs in a puzzle like structure). In such fashion, the “formularizer information” 1801 (FIG. 18A), which in this example is an integral part of the eeggi instead of an associated or reference type information, is used to define the range of possible values that the particular adjective eeggi can be incorporated or integrated into. As a result, adjectives and other grammatical elements can be classified not only by its metric value, but also its relevance, type, purpose, and other possible factors of importance. Furthermore, the inappropriate integration or encapsulation of eeggis and concepts is diminished or avoided, such as integrating an enhancer adjective with a noun (i.e., integrating the enhancer “very” with the noun “John”). Additionally, the method further allows the ability to select the precise eeggi when a word has several meanings or eeggis. For example, when a first word identifies several eeggi (meanings), only one of the eeggi acting as an adjective could be incorporated into the neighboring second word or noun eeggi, as depicted by the next figure. In FIG. 18B, the exemplary noun eeggi 1820 (FIG. 18B) is capable of incorporating up to two “vx” type eeggis 1821 (FIG. 18B), and one “tw” type eeggi 1822 (FIG. 18B). The selection of possible eeggis that could potentially be incorporated are: “AK23000” 1860 (FIG. 18B), which is a “AK” type, “VX5000” 1800 (FIG. 18B) which is a “vx” type, and finally “GN919000” 1870 (FIG. 18B) which is a “GN” type. Visibly, only the “vx” type or “VX5000” 1800 (FIG. 18B) can be incorporated, thus re-formulating the initial eeggi noun 1820 (FIG. 18B) into the final compound noun eeggi 1850 (FIG. 18B) which now includes the “vx” type information or eeggi 1851 (FIG. 18B). Noteworthy, in this example, the additional value information field “tw” is reserved for integrating other grammatical elements such as an article per se. FIG. 18C and FIG. 18D illustrate two sampling metric relationships or interactions between an adjective and its enhancer (special type of adjectives). In FIG. 18C, the phrase in the corpus of information 1800 (FIG. 18C) comprises the enhancer “very” 1805 (FIG. 18C) and its corresponding adjective “ugly” 1806 (FIG. 18C). As illustrated, by the eeggi table or lexicon 200 (FIG. 18C) the word or enhancer “very” 201 (FIG. 18C) identifies the eeggi “KL20,” which has a value of “+20” (and/or an additional active metric value of “20”) and the word or adjective “ugly” 202 (FIG. 18C) identifies the eeggi “VX5000,” which has a metric conceptual value of “5000.” Therefore, according to the equation 1875 (FIG. 18C), the total conceptual metric value of the corpus 1800 (FIG. 18C) totals or equals “5020.” Therefore, a record comprising the value of “5020” which according to the lexicon 200 (FIG. 18C) equals to the word “hideous” 203 (FIG. 18C) will be found and/or retrieved (very ugly=hideous). In FIG. 18D, the phrase in the corpus of information 1800 (FIG. 18D) comprises the de-enhancer “not so” 1807 (FIG. 18D) and its corresponding adjective “pretty” 1808 (FIG. 18D). In the lexicon 200 (FIG. 18D), the words “not so” 207 (FIG. 18D) have a value of “−20” (and/or an additional metric value of “−20”) and the word (adjective) “pretty” 208 (FIG. 18D) has a value of “9000.” Therefore, performing the mathematical operation 1885 (FIG. 18D) produces a total conceptual metric value for the corpus 1800 (FIG. 18D) equal to “8980.” Thus, a record comprising the word “cute” 209 (FIG. 18D) which according to the lexicon 200 (FIG. 18D) has a value of “8980” will be retrieve when such query is searched. Noteworthy, conceptually speaking, the word “pretty” is or was modified by its enhancer or de-enhancer to provide other meaning than its original single intended purpose; therefore, if the CoSMo would have been set to “zero” (not to permit other concepts but only those identical to the query) the retrieval would have avoid the word “pretty” by itself (unaffected). However, if the CoSMo allows other values such as “9000,” then the word “pretty” by itself, would have being retrieved. This retrieval behavior samples a major difference in comparison to current and visualized technologies, which are fully focused in the retrieval of information “by existence” of the grammatical elements rather than the intensity of the concept. Noteworthy, the presently disclosed inventive method can also retrieve information “by existence” imitating current technologies should the user decided such behavior, simply activating such feature at a click of a button per se. FIG. 18E illustrates a plurality of similar type eeggis interrelating with each other describing composed words such as “television stand.” The word elements “television” 1890 (FIG. 18E) and “stand” 1891 (FIG. 18E) identifies a single component implementing two words. In similar fashion, their respective eeggis “NGp37849” 1892 (FIG. 18E) and “NGp2828” 1893 (FIG. 18E) identify such component interacting with each other, thus forming the multiple compound noun eeggi 1899 (FIG. 18E). In such fashion, a query such as “stand for television” can still formed an extremely similar or same multiple compound eeggi, thus allowing the search engine to find and retrieve the information referring to “television stand”.

Another important and worthy capability is that since adjectives are incorporated into the nouns, adverbs into the verbs, articles into the adjectives, etc. the retrieval of information can be prioritized by the type of element (noun over adjective, verbs over adverbs, etc.), but most importantly, the method suggests the possibility that an adjective eeggi can not be found or be retrieved unless its noun eeggi is also present directly or indirectly in the query; thus permitting “directional conceptual searching” as illustrated by the following figure.

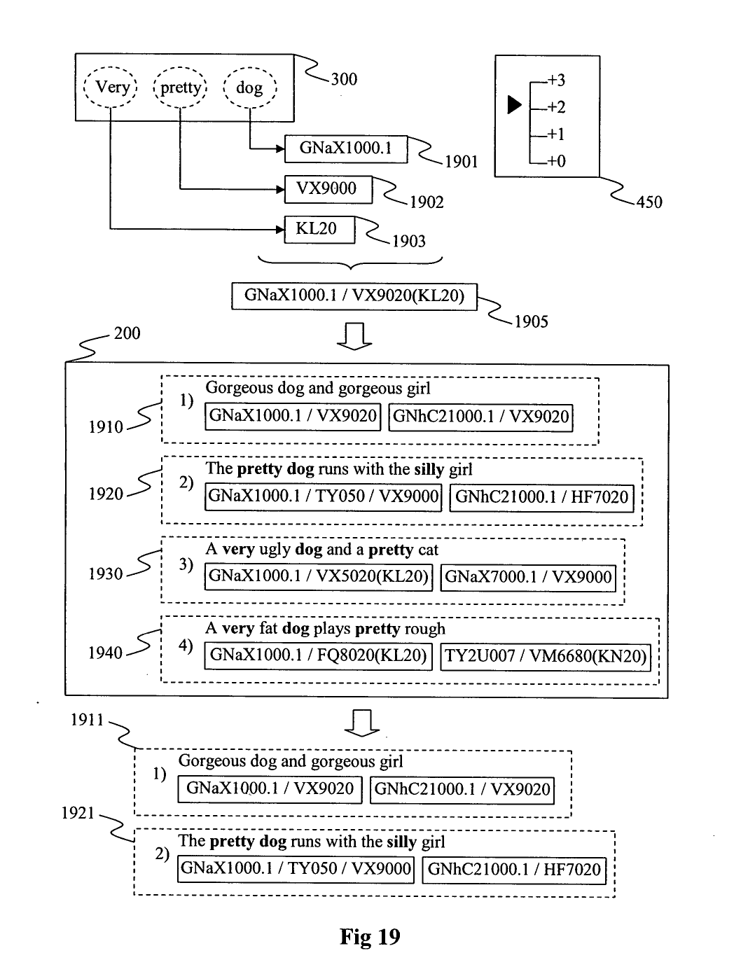

FIG. 19 is an illustration of a featured here introduced as “directional conceptual searching,” which is possible through the implementation of compound eeggis. The query 300 (FIG. 19) comprising three words is transformed into their respective eeggi, such as the enhancer eeggi 1903 (FIG. 19) which is mathematically incorporated into the adjective eeggi 1902 (FIG. 19), which is return is integrated by the noun eeggi 1901 (FIG. 19), thus forming the compound noun eeggi 1905 (FIG. 19) or new eeggi query for searching the source of information 500 (FIG. 19). In the source of information 500 (FIG. 19) there are four possible records. The first record 1910 (FIG. 19) contains one eeggi matching that of the eeggi query 1905 (FIG. 19); thus becoming one of the retrieved records 1911 (FIG. 19). Please note that in this first record, the word “gorgeous” is used. The word “gorgeous” is an identical conceptual metric match to “very pretty” from the query, thus becoming a retrievable record. In the source of information 500 (FIG. 19), the second record 1920 (FIG. 19) is also retrieved and displayed in the results as the last retrieved record 1921 (FIG. 19) thanks to the CoSMo 450 (FIG. 19), which is permitting the retrieval of underlying eeggis with similar values. However, in the source of information 500 (FIG. 19), the third record 1930 (FIG. 19) although containing all of the words present in the initial query 300 (FIG. 19) will not be retrieved, since no underlying compound eeggi matches that of the eeggi query 1905 (FIG. 19). Please note, current technology would have retrieved such record which conceptually speaking, has nothing in common with the initial query 300 (FIG. 19). In similar fashion, in the source of information 500 (FIG. 19) the fourth record 1940 (FIG. 19) containing of two eeggis, does not offer any compound eeggi to match that of the eeggi query 1905 (FIG. 19), therefore the search engine does not retrieve such record either. Noteworthy, according to standard methodologies, the third record 1930 (FIG. 19) and fourth record 1940 (FIG. 19) would have being retrieved; but the compound eeggis of the disclosed inventive method removed such a possibility by allowing the search engine to also focus in the conceptual structure (compound eeggis) rather than the simplistic existence of words. In addition, the word or eeggi of “pretty” can assume a secondary priority in the corpuses of information since the word “dog” or noun eeggi is the parent eeggi (contains the adjective eeggi). In such fashion, more advanced features and functions can manipulate, ignore, delete or even ranked results based not only on retrievable eeggis but also on those eeggis that do not form an integral part of the query itself; such as: if the query contains no noun eeggis, then the retrieval of incorporating type eeggis (adjective eeggis and others) is possible, while if the query contains noun eeggis, then the retrieval of incorporating type eeggis is secondary or conditioned to the noun eeggi only, etc.

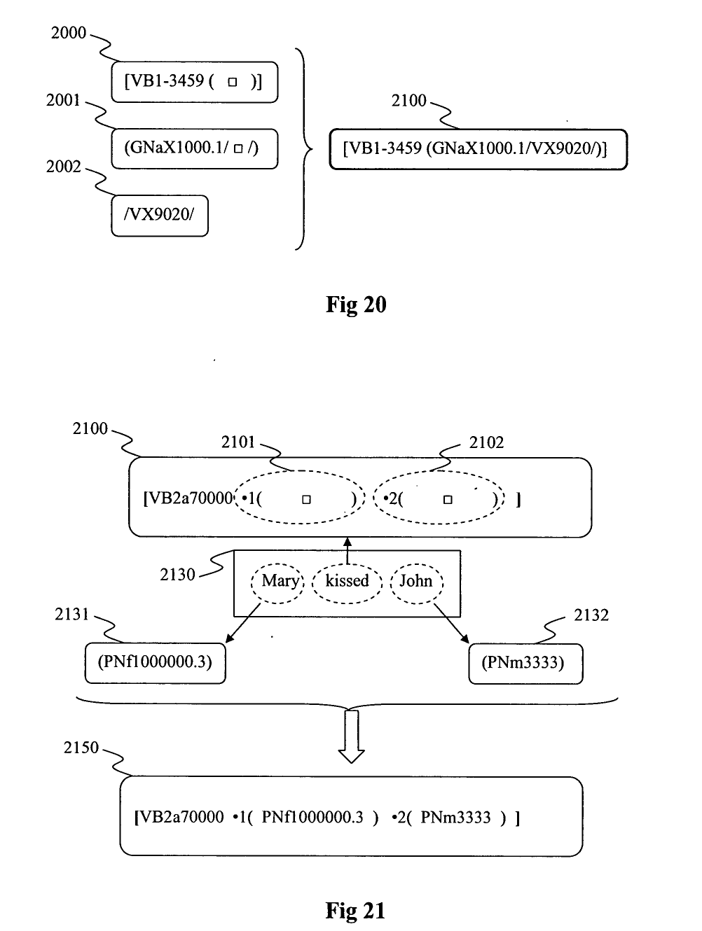

FIG. 20 illustrates a non-limiting example of an eeggi for identifying a type-1 verb. Type-1 verbs are those verbs which their identifying action affects or interacts with a single noun or a single noun group. For example, the verb “run” is a type-1 verb since its action of “running” affects only the noun to which it is referring to. In FIG. 20, an eeggi for identifying a type-1 verb is displayed. The type-1 verb eeggi 2000 (FIG. 20) graphically illustrates the section or portion “(□)” indicating its capability for incorporating a “( )” type information, which in this example is reserved for noun eeggis. The noun eeggi 2001 (FIG. 20) is delimited by such symbols or values “( )” implying that its incorporation into the verb eeggi 2000 (FIG. 20) is possible, feasible or granted. In addition, the noun eeggi 2001 (FIG. 20) is also capable of incorporating any information delimited or comprised of the symbols “/□/” as illustrated; which is this example is reserved for adjective type elements such as the adjective eeggi 2002 (FIG. 20). As a result, the adjective eeggi 2002 (FIG. 20) will be incorporated into the noun eeggi 2001 (FIG. 20) which in return will be incorporated into the verb eeggi 2000 (FIG. 20) for finally forming the compound verb eeggi 2100 (FIG. 20). Please note, this example made double use of the eeggi's first and last information (edges or symbols “[ ]” “( )” “//”) describing not only its beginning and end; but also to define its almost geometric type properties or puzzle like delimitations for the eeggis to associate, incorporate or interact in between each other. In such fashion, since an adjective can be integrated into a noun, and a noun integrated into a verb, etc. a query for an adjective may compel the search engine to search for such information even within the inner workings of compound verb eeggis, while on the hand, the search for a verb, can potentially be limited to only the outer limits of the eeggis in question. As a result, the information delimiters or information describing the perimeter of a given eeggi, such as the “( )” symbols, the “[ ]” symbols, and the “//” symbols used in the present non-limiting example, may or may not, fully demarcate the end, the beginning, or even the continuation of a search for a particular type eeggi.

FIG. 21 illustrates a non-limiting example of an eeggi for identifying a type-2 verb. Type-2 verbs are those verbs which their action associates two word elements, such as nouns. For example, the verb “kissed” is a type-2 verb because it associates two nouns through a particular action, while implying a particular direction of the act as well. In FIG. 21, the type-2 verb eeggi 2100 (FIG. 21) illustrates two additional conceptual information fields such as the first field 2101 (FIG. 21) delimited by the “(□)” symbols and ready for incorporating a first noun, and the second field 2102 (FIG. 21) ready for incorporating a second noun and also delimited by the “(□)” symbols. Please note, the field for the first noun 2101 (FIG. 21) comprises the exemplary number “1” for establishing the origin of the verb's action, and the second noun field 2102 (FIG. 21) comprising the number “2” for identifying the terminal or final direction of the verb's action. In such fashion, the English corpus of information 2130 (FIG. 21) mentioning that “Mary kissed John;” establishes that “Mary” is the origin of the verb's direction, and that “John” is the final or terminal direction of the action. As consequence, Mary's eeggi 2131 (FIG. 21) is incorporated into the first noun field 2101 (FIG. 21); and John's eeggi 2132 (FIG. 21) is incorporated into the empty second noun field 2102 (FIG. 21), producing the compound type-2 verb eeggi 2150 (FIG. 21) containing both nouns, and also respecting the conceptual order pr direction inherently established by the exemplary English corpus of information. Noteworthy, a query such as “John kissed Mary” shapes its verb eeggi to “[Kissed•1(John)•2(Mary)] identifying a different or opposite order of elements than those depicted by the exemplary eeggi of FIG. 21. As a result, the compound or exemplary eeggi 2150 (FIG. 21) will not, and should not be retrieved under such querying circumstances. Please note, in addition to articles, conjunctions, pronouns, and others, natural languages also make use of the location of the word elements to establish the direction of information, and to also group the different sections of interacting data. For example, in a language like English, an adverb relates to its immediate neighboring verb and not to other verbs distant or five words away. It is this important spatial interrelationship that can quickly and ultimately be used to group large numbers of eeggis for outlining a superior platform to store and find human information.

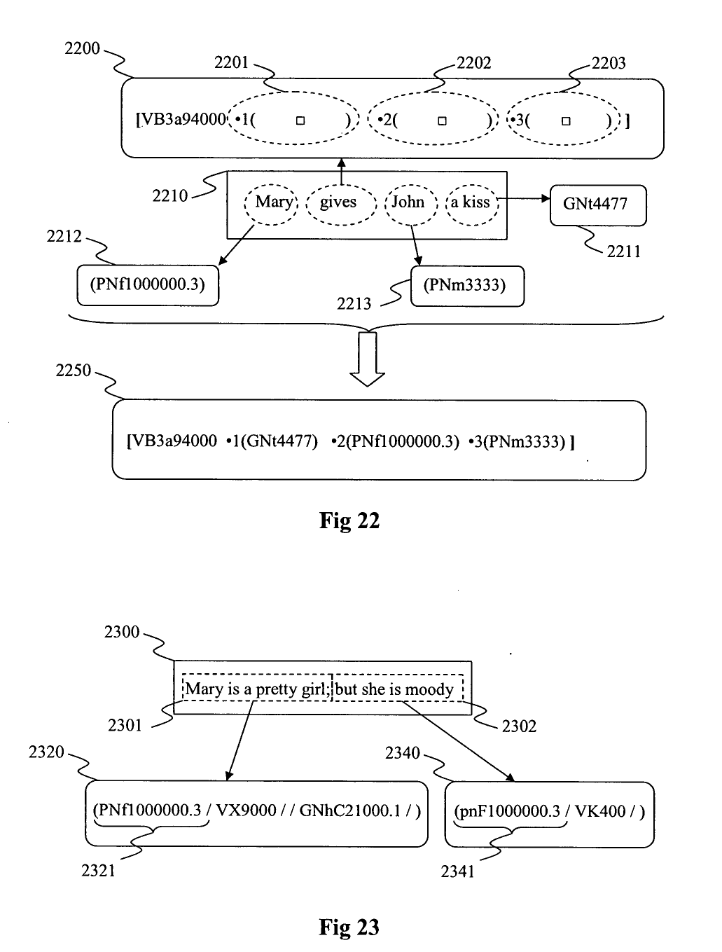

FIG. 22 illustrates a non-limiting example of an eeggi identifying a type-3 verb. Type-3 verbs are those verbs which associate three grammatical elements into a particular shape or form. For example, the verb “gives” is a type-3 verb, subclass A, since it depicts that something (first element) is being provided from one element (second element) to another (third element). For example, in English, the sentence “Mary gives John a kiss” implies an spatial relationship in which the first element “kiss” is being given or provided by second element or “Mary,” to the third element or “John.” In FIG. 22, the type-3 verb eeggi 2200 (FIG. 22) enables the incorporation of a first element 2201 (FIG. 22) or the entity being given, a second element 2202 (FIG. 22) or giver entity, and a third element 2203 (FIG. 22) or receiver entity. In such fashion, in the English corpus 2210 (FIG. 22) the first element is the word “kiss,” thus integrating its eeggi 2211 (FIG. 22) into the first field 2201 (FIG. 22) of the verb type-3 eeggi. In similar fashion, the word “Mary” been the giver or second element implies that its eeggi 2212 (FIG. 22) be incorporated into the corresponding second field 2202 (FIG. 22) of the verb eeggi. Finally, the remaining word “John” or receiver is the third element, thus incorporating its eeggi 2213 (FIG. 22) in the reserved third field 2203 (FIG. 22) of the verb. The result is the integrated or compound verb eeggi 2250 (FIG. 22) including the three elements' information. Noteworthy, a sentence such as “John gives Mary a kiss” installs the noun eeggis into different fields or locations within the verb eeggi itself; thus creating a different compound eeggi, enabling the search engine to differentiated between both actions. Furthermore, the verb eeggi permits the identification of incomplete data, such as the unfinished query of “John gives a kiss,” which according to its type-3 verb, is missing an element (to whom John is giving a kiss) thus suggesting the ability for the search engine to request the missing element or information from the user. Moreover, such an incomplete query “John gives a kiss,” which leaves the eeggi's third field empty, can still form a compound eeggi with no possibilities to ever match the compound eeggi from FIG. 22, thus still avoiding its retrieval filtering out irrelevant information. In addition, specialized language eeggis are possible, resembling the allocations of the elements as they occur in the particular target language to further facilitate the incorporation of possibly loose or unidentified eeggis. Please note, at the beginning of the detailed description of the present figure (FIG. 22), the verb type-3 eeggi was said to be a sub-class A, referring to the effect that the verb can be substituted or transformed into a type-2 verb eeggi such as the eeggi of the verb “kiss” which is conceptually identical to “give a kiss” or in other words, “Mary gives John a kiss” equals “Mary kisses John.” Such transformation or substitution can be attained through the aid of additional relational eeggi databases or other regulatory and transformative means.

FIG. 23 illustrates a pronoun type eeggi associating its information to its noun type eeggi. In natural language, pronouns are used to substitute a noun that has been previously established or mentioned. In similar fashion, a pronoun type eeggi is engineered to relate all its information to the original or previously established noun eeggi. In FIG. 23, the phrase “Mary is a pretty girl; but she is moody,” 2300 (FIG. 23) is represented by two eeggis. The first noun eeggi 2320 (FIG. 23) represents the first portion 2301 (FIG. 23) of the phrase (“Mary is a pretty girl”), while the second pronoun eeggi 2340 (FIG. 23) represents the second portion 2302 (FIG. 23) of the phrase (“but she is moody”). Please note, in the pronoun eeggi 2340 (FIG. 23) its value 2341 (FIG. 23), is nothing else than a “mirror or copy of inverted capitals” of the value 2321 (FIG. 23) of the original noun eeggi 2320 (FIG. 23). In such fashion, any information incorporated by the pronoun eeggi 2340 (FIG. 23) is equally accessible through the noun eeggi 2320 (FIG. 23) or vice versa.

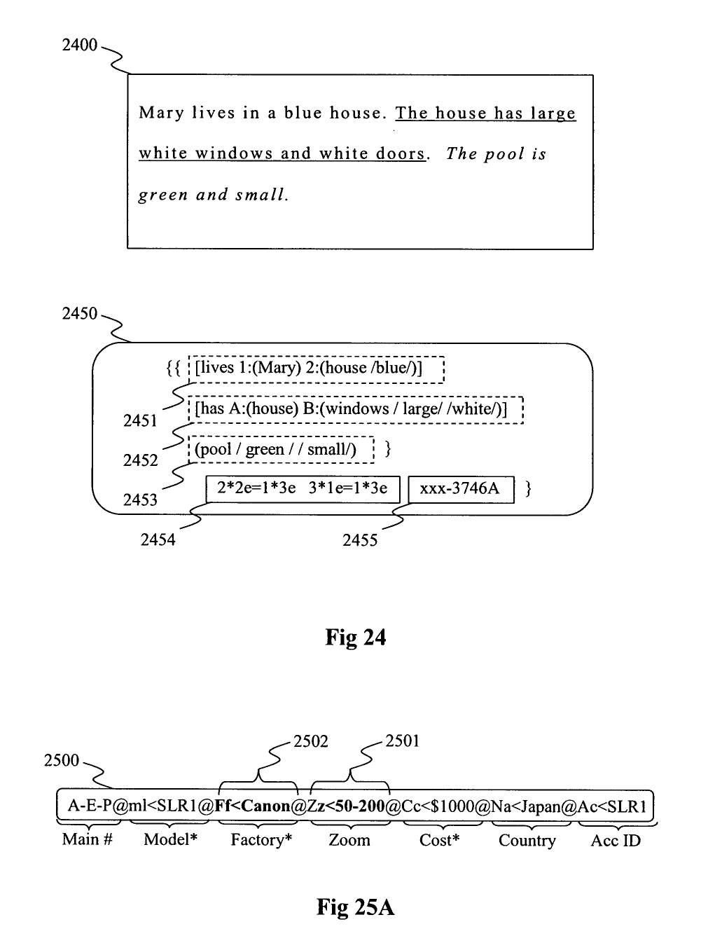

FIG. 24 illustrates a paragraph type eeggi capable of incorporating several types of eeggis and their distinctive associations and/or adding additional associations not established or available by the eeggis themselves. In FIG. 24 the corpus of data 2400 (FIG. 24) comprises three English sentences which are also depicted in the eeggi type paragraph 2450 (FIG. 24). Please note, due to the limitations of an illustration, the English sentences have being separated in the following manner: the first English sentence is depicted implementing normal text, the second English sentence is underlined, and the third sentence is written in Italic format. Returning to FIG. 24, the first English sentence “Mary lives in a blue house” produces the first eeggi 2451 (FIG. 24), the second English sentence (underlined) produces the second eeggi 2452 (FIG. 24), and the third English sentence produces the third eeggi 2453 (FIG. 24). Please note, in order to facilitate this exemplary illustration, the values of the eeggis have also been substituted with their English identifiers or words. In such fashion, the eeggis representing the three English sentences are all incorporated by the paragraph eeggi 2450 (FIG. 24). In addition, the paragraph eeggi 2450 (FIG. 24) depicts the associative eeggi table 2454 (FIG. 24) which associates the different eeggis or their segments. For example, the information “2*2e=1*3e” implies that in the second eeggi 2452 (FIG. 24), its second element (house) relates or equals the third element (house) of the first eeggi 2451 (FIG. 24). In similar fashion, the information “3*1e=1*3e” implies that the first element (pool) of the third eeggi 2453 (FIG. 24) relates to the second element (house) of the second eeggi 2452 (FIG. 24), therefore “pool” relates to “house,” which in turn relates to “Mary.” As a result, the query “Mary green pool” can find the English paragraph 2400 (FIG. 24) implementing the paragraph eeggi 2450 (FIG. 24). Also depicted in FIG. 24 is the paragraph eeggi identification number 2455 (FIG. 24) which ultimately can relate several paragraph eeggi with each other. Noteworthy, a query such as “Is Mary's pool green?” can potentially be answered as “YES” by the search engine while retrieving the source of information, if and only if, a positive search (find value) is experienced.

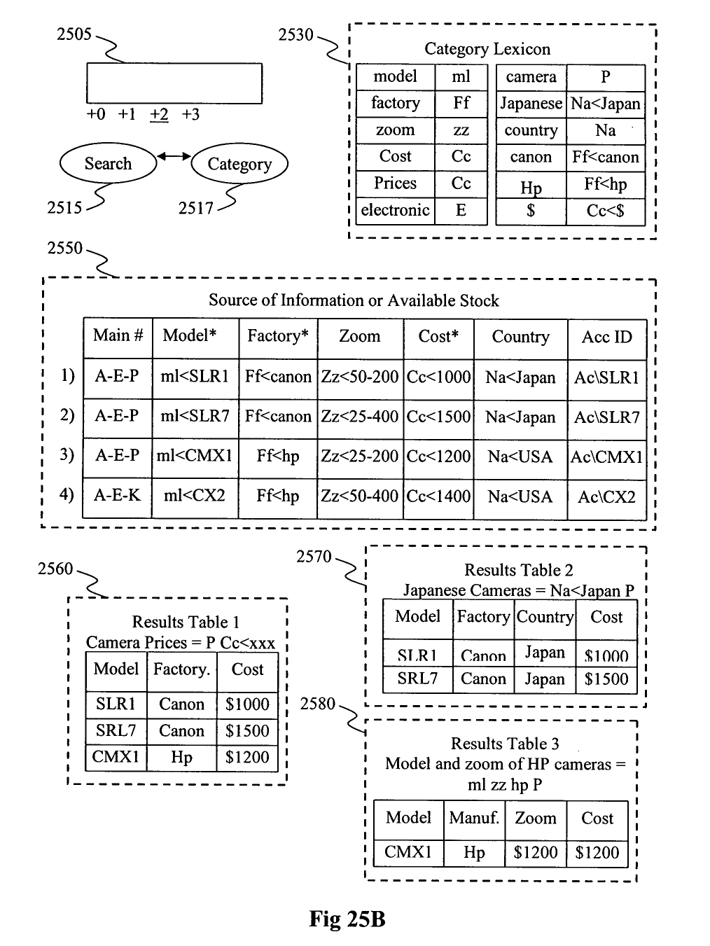

FIG. 25A illustrates a non-limiting example of an inventory noun eeggi which may be utilized to describe or identify items of stock or supply, specifically for permitting and manipulating categorizing queries and results. The inventory eeggi 2500 (FIG. 25A) includes several spectrums or fields for incorporating category and feature information, such as the zoom information eeggi 2501 (FIG. 25A) or “zz<50-200” and the manufacturer or factory information eeggi 2502 (FIG. 25A) or “Ff<Canon.” Please note, the feature or category eeggi includes the feature value or information which is separated or identified by the “<” symbol. In such fashion, the feature or category's respective value can be quickly delivered simply by removing the eeggi's identification portion from the results, such as removing “zz<” for describing the zoom, and removing “Ff<” for disclosing the manufacturer. FIG. 25B illustrates a non-limiting illustration of an exemplary search or categorization or results using sample values or eeggis. The search field 2505 (FIG. 25B), receives a category type query such as “camera prices.” Right clicking the Search button 2515 (FIG. 25B), which in this example is using the shape of an egg as a logo, allows the user to replace it with the category button 2517 (FIG. 25B) for activating the category function (note: the category function can also be activated simply by typing “categorize” in the query). After selecting the type of search function (search versus categorize) clicking on the category button 2517 (FIG. 25B) allows the search engine to implement the querying elements as possible columns to display results in tabular format (or other). Because of the activation of the category function, the category lexicon 2530 (FIG. 25B) is implemented to transform the original word entry into eeggi. In such fashion the original word query “camera prices” becomes the eeggi category query “P Cc<.” Therefore, in the Available Stock 2550 (FIG. 25) or Source of Information, only eeggis 1) through 3) match the term “P” and their respective value fields are displayed by also removing the “ml<” portion, the “Ff<” portion and the “Cc<” term or portion from the eeggi. The first results table 2560 (FIG. 25B) displays such outcome. Please note, the eeggis in the Source of Information 2550 (FIG. 25B) are displayed as part of a table to facilitated this illustration. A second word input or category query such as “Japanese cameras” is treated in identical fashion, implementing the category lexicon 2530 (FIG. 25) to transform the words in the query to their respective eeggis, thus forming or discovering the eeggi query “Na<Japan P” to retrieve results. In the Source of Information 2550 (FIG. 25B) only eeggis 1) and 2) match such criteria, thus producing the second results table 2570 (FIG. 25B) illustrates such eeggis or outcome; wherein once again, the “ml<” portion, the “Ff<” portion and “Na<” portion of the eeggis was removed or omitted from the results. In addition, please note that other non-requested values or eeggi information appears in the results. This is because the eeggi in the field has the character “*” as part of the value, indicating that its information must always be furnished or displayed. In addition, the incorporated eeggi information may also enjoy such a feature to display its results, while optionally information actually requested from the original query may be highlighted or display using bold characters, etc. A third or final query such as “model and zoom of HP cameras” becomes the eeggi query “ml zz hp P” which according to the Source of Information 2550 (FIG. 25B) only the third eeggi or eeggi 3) matches such criteria. The third result table 2580 (FIG. 25B) illustrates such an outcome. Please note that a category search may ignore some word elements in the original query that do not have an eeggi in the category lexicon. In such fashion a category query such as “show me the model, and price of cameras” can still display results, wherein the words “show me the” can simply be discarded. In addendum, please note the last field or Acc ID type eeggi which can associated the current camera eeggi to other incorporating eeggis or eeggis of other items.

In addendum other important features such as numeric analysis and statistical analysis can further enhance the accuracy of the search engine, while a method of allowing the users to vote, discard or acknowledge good and/or bad results and records will push the effectiveness and engineering of superior eeggis of the search engine even further.

Noteworthy, the eeggis of articles and other minor grammatical elements that could also incorporate their values into their respective parent type eeggi are not displayed or contemplated in this disclosure, in addition to the implementation of multiple transformations and evaluations to discriminate or select proper or superior eeggis and functions. In addendum, more detailing characteristics and properties of the particular grammatical elements and their eeggis has not being observed in full detail, since the number of elements and their characteristics is extremely large (such as that of many types of nouns like “house” and “dog” which because of their nature permits certain incorporations as demonstrated by the following two phrases “Walter is in the HOUSE,” and “Walter is in the DOG”) will render this disclosure non-objective.

Noteworthy, the eeggis, their identifying grammatical elements, their assigned values, their additional information, mathematical operations and further interactions are only exemplary and used for illustrating the disclosed inventive method and some variations. In addition, more evolving lexicons and other associations can further enhance the behavior, characteristics and searching capabilities of the disclosed search and retrieval method(s). Furthermore, the conceptual values of particular elements can change or be further modified based upon the existence of other elements and/or their conceptual values present in the corpus of data or rules applicable to the particular corpus of data. For example, in the phrase “the puppy runs quickly” the value of the verb can be decreased to 90% of its original value, since the verb is modified by an adverb describing a speed versus another adverb that could describe a state such as “the puppy runs funny.”

The enablement(s) described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

### CONCLUSION

From the foregoing, a novel method of identifying, storing, searching and/or retrieving of information can be appreciated. The described method overcomes the conceptual limitations encountered by textual search engine and synonyms search engines by providing superior searching and selecting capabilities, thus providing superior and cognitive results. Furthermore, the method is capable of accommodating conceptual metric interactions for redefining concepts with in a particular corpus of information, thus searching for cognitive relevance and values rather than the mere existence of terms or words. Furthermore, the method accommodates the pre-established incorporation of adjectives to nouns, adverbs to verbs and other type interrelations to provide directive conceptuality of information.

1. A method for searching and retrieving information, the method comprising the steps of:
a) Implementing a first value for identifying a word;
b) Implementing a second value for calculating at least one of a: third value, and value range implementing said first value;
c) Calculating at least one of a: third value, and value range;
d) Searching implementing at least one of a said: first value, third value, and value range;
e) Providing a word corresponding to at least one of a said: searched first value, searched third value, and searched value range.

2. The method for providing values to a word for searching, the method including the steps of:
a) Identifying a word;
b) Implementing a value for identifying said word.

3. The method of claim 1, wherein said group of words involves a word from a first language and a second word with similar meaning of a second language.
a) Implementing a first value for identifying a word from a query;
b) Retrieving information implementing information from said first value;
c) Implementing a second value for calculating at least one of a: said first value, third value, and value range
d) Distilling a field of information implementing at least one of a said: first value, third value and value range.

4. The method of claim 1, wherein said information of step (a) involves modifying an existing information identifying a word.

5. The method of claim 1, wherein said information of step (a) involves replacing an existing information identifying said word

6. The method of claim 1, comprising the additional steps after step (a) of:
Storing said information identifying a plurality of said group of words

7. The method of claim 1, further comprising implementing and information for identifying a language.

8. A method for identifying a meaning element, such as words, text, and sounds, the method comprising the steps of:
a) Identifying a meaning element in a first field of data;
b) Identifying said meaning element in a second field of data comprising at least one information identifying a set of meaning elements;
c) Implementing said information for identifying said meaning element of said first field of data.

9. A software process claim

10. From picture 14. A method for providing a search selective action.
1. Identifying an input information identifying at least one of a: word, idiom, phrase and sentence.
2. Identifying an additional information identifying at least one of a: word, phrase and sentence
3. Displaying an information identifying an information identifying said additional information.
4. Performing a selecting action including: keeping, removing and adding at least one said additional conceptual information
5. Producing results based on said selecting action.

11. The above of claim 10 but only to display
